(19) United States
(12) Patent Application Publication
(10) Pub. No.: US 2024/0138037 A1
(43) Pub. Date: Apr. 25, 2024

(54) OVEN

(71) Applicant: LINCAT LTD., Lincoln, Lincolnshire (GB)

(72) Inventor: Andrew Jackson, Lincoln, Lincolnshire (GB)

(21) Appl. No.: 18/546,863

(22) PCT Filed: May 18, 2022
(86) PCT No.: PCT/GB2022/051262

§ 371 Date: Aug. 16, 2023

(30) Foreign Application Priority Data
May 25, 2021 (GB) 2107486.9
Nov. 23, 2021 (GB) 2116874.5

(51) Int. Cl. H05B 6/64

(52) U.S. Cl. CPC H05B 6/6485; H05B 6/645

(57) ABSTRACT

An oven defines an oven cavity for receiving a food product for heating and comprises a housing, a door for closing the oven cavity, means for heating, means for providing air circulation, means for measuring temperature and a controller for controlling the operation of the heating means and the operation of the means for measuring temperature, wherein the means for heating comprises an oven element provided in the top section of the oven, a base element provided in the base of the oven and a microwave source, the oven cavity has a base which is ceramic and defines a heating surface which is heated by the base element in use of the oven, the base element is a radiant element, the housing comprises a floor section located between the ceramic base of the oven cavity and the base element, the floor section comprises a metal body provided with apertures, the metal body lying over the base element, the means for measuring temperature comprises a first temperature sensor and a second temperature sensor, the first temperature sensor is located in the base section of the oven and is located between the base element and the metal body, the second temperature sensor is located in the oven cavity remote from the ceramic base, and the controller is configured to control independently the temperature of the ceramic base and the temperature within the oven cavity.

The present disclosure relates to an oven, in particular to an oven comprising a plurality of independently operable and co-operable heating means, independently operable and co-operable means for measuring temperature and a controller for controlling the operation of the heating means and the operation of the means for measuring temperature.

Various heating apparatus exist including convection ovens, contact grills and pizza ovens which use a single heating source. Some apparatus exist which combine various types of heating including accelerated heating apparatus which also use microwaves to shorten cooking time.

The present invention arose with the aim of providing an improved oven which would allow different types of food, including pizzas and sandwiches, to be heated quickly, evenly and safely with better quality.

According to the present invention in one aspect there is provided an oven defining an oven cavity for receiving a food product for heating, the oven comprising a door for closing the oven cavity, means for heating, means for providing air circulation, means for measuring temperature and a controller for controlling the operation of the heating means and the operation of the means for measuring temperature, wherein
the means for heating comprises an oven element provided in a top section of the oven, a base element provided in a base section of the oven and a microwave source,
the oven cavity has a base which is ceramic and defines a heating surface which is arranged to be heated by the base element in use of the oven,
the base element is at least one radiant element,
a metal body provided with apertures is located in the base section of the oven and is located between the ceramic base of the oven cavity and the base element,
the metal body lies over at least part of the base element,
the means for measuring temperature comprises a first temperature sensor and a second temperature sensor,
the first temperature sensor is located in the base section of the oven and is located between the base element and the metal body,
the second temperature sensor is located in the oven cavity remote from the ceramic base, and
the controller is configured to control independently the temperature of the ceramic base and the temperature within the oven cavity.

According to the present invention in another aspect there is provided an oven defining an oven cavity for receiving a food product for heating, the oven comprising a door for closing the oven cavity and means for heating, means for providing air circulation, means for measuring temperature and a controller for controlling the operation of the heating means and the operation of the means for measuring temperature, wherein
the means for heating consists of an oven element provided in a top section of the oven, a base element provided in a base section of the oven and a microwave source,
the oven cavity has a base which is ceramic and defines a heating surface which is arranged to be heated by the base element in use of the oven,
the base element is at least one radiant element,
a metal body provided with apertures is located in the base section of the oven and is located between the ceramic base of the oven cavity and the base element,
the metal body lies over at least part of the base element,
the means for measuring temperature comprises a first temperature sensor and a second temperature sensor,
the first temperature sensor is located in the base section of the oven and is located between the base element and the metal body,
the second temperature sensor is located in the oven cavity remote from the ceramic base, and
the controller is configured to control independently the temperature of the ceramic base and the temperature within the oven cavity.

According to the present invention in a further aspect, there is provided an oven defining an oven cavity for receiving a food product for heating, the oven comprising a housing, a door for closing the oven cavity, means for heating, means for providing air circulation, means for measuring temperature and a controller for controlling the operation of the heating means and the operation of the means for measuring temperature, wherein
the means for heating comprises an oven element provided in a top section of the oven, a base element provided in a base section of the oven and a microwave source,
the oven cavity has a base which is ceramic and defines a heating surface which is arranged to be heated by the base element in use of the oven,
the base element is at least one radiant element,
the housing comprises a floor section located between the ceramic base of the oven cavity and the base element, and the floor section comprises a metal body provided with apertures,
the metal body lies over at least part of the base element,
the means for measuring temperature comprises a first temperature sensor and a second temperature sensor,
the first temperature sensor is located in the base section of the oven and is located between the base element and the metal body,
the second temperature sensor is located in the oven cavity remote from the ceramic base, and
the controller is configured to control independently the temperature of the ceramic base and the temperature within the oven cavity.

In these embodiments, the first temperature sensor is located outside the oven cavity and adjacent the ceramic base. The first temperature sensor preferably measures the air temperature below the ceramic base during the heating process as a way of indirectly measuring the temperature of the ceramic base. The air may be provided in an air pocket below the ceramic base.

In alternative embodiments, the first temperature sensor is located elsewhere outside the oven cavity and adjacent the ceramic base

In yet further embodiments, the first temperature sensor is located inside the oven cavity and adjacent the ceramic base as a way of measuring the temperature of the ceramic base. The first temperature sensor may be provided in a sealed housing or another form of housing which is impermeable to microwaves so that it is suitably screened from microwaves during use of the oven. For example, the first temperature sensor is housed in its own Faraday cage.

The features of the dependent claims apply to all these embodiments of the present invention.

The independent control of the operation of the base element from the operation of the other heating means results in the ability to provide different temperatures between the ceramic base and the air in the oven cavity, providing more accurate control of the cooking of food.

According to the present invention, the temperature of the ceramic base is able to be controlled independently of the temperature of the air inside the oven cavity.

The controller preferably also controls system parameters such as air circulation speed and the duration/power of incident microwaves.

The oven of the present invention is generally configured to operate as a microwave oven and as a convection oven.

The means for measuring temperature may also comprise electronics associated with the temperature sensors.

The second temperature sensor is located in the oven cavity remote from the ceramic base. It is preferably located adjacent the top section of the oven. The second temperature sensor measures the air temperature in the oven cavity during the heating process.

Since the second temperature sensor is located inside the oven cavity, it may be provided in a sealed housing or another form of housing which is impermeable to microwaves so that it is suitably screened from microwaves during use of the oven. For example, the second temperature sensor is housed in its own Faraday cage.

The second temperature sensor is positioned and configured to measure the air temperature inside the oven cavity for controlling temperature. The first temperature sensor is positioned and configured to measure the temperature of the ceramic base for controlling temperature.

The metal body provided with apertures is impermeable to microwaves. It provides a metal surface. The metal body is sandwiched between the ceramic base of the oven cavity and the base (radiant) element. Preferably, no components of the oven, other than the metal body (and any temperature sensor(s)), are located between the ceramic base and the base element.

The metal body lies over the base element to cover at least part of the side of the base element facing the metal body. In use of the oven, this side of the base element is its upper side, this upper side facing the lower side of the metal body. The upper side of the metal body faces the lower side of the ceramic base of the oven cavity. The upper side of the ceramic base is exposed to the oven cavity.

The metal body may lie substantially over a radiating area of the base element. The radiating area is the region or regions of the base element that are configured to radiate heat in use of the oven.

The apertures in the metal body provide for the transfer of heated air from the base element to the ceramic base of the oven cavity. The apertures in the metal body may be in one or more regions which are substantially aligned with the base element. In particular, the apertures in the metal body may be in one or more regions which are substantially aligned with the radiating area of the base element.

The base element may extend over more than 80% of the whole surface area of the ceramic base of the oven cavity. The metal body preferably extends substantially over the radiating area of the base element.

Preferably, the base element is not in direct thermal contact with the ceramic base of the oven cavity.

The oven of the present invention may be provided with more than one base element.

The base element may consist of one or two radiant elements. It may be an open wire radiant element.

In one embodiment, a central region of the metal body is provided with apertures.

The ceramic base of the oven cavity may be ceramic glass or may be another ceramic material, for example, a material used to make baking stones, which are typically made of fired clay.

The material used for the ceramic base of the oven cavity is selected to provide mechanical stability to the housing of the oven and to be heated without distortion. The ceramic base of the oven cavity may be fixed in the oven cavity or removable from the oven cavity, revealing the metal body (with apertures) beneath it.

The ceramic base of the oven cavity defines a heating surface for direct contact with food to be cooked. Therefore, food items such as pizza and sandwiches may be placed directly on the ceramic base for direct heating. The heating surface of the ceramic base is therefore for cooking and the heating surface is able to provide a direct cooking surface.

Power to the base element is preferably either continuous, pulsed or regulated by a thermocouple or another type of temperature sensor (and controlled to a set temperature).

The microwave source may comprise a magnetron concealed in the oven: for example, the magnetron is concealed in a top section or wall of the oven.

The microwave source may also comprise a waveguide which directs the microwave energy generated by the magnetron into the oven cavity. The waveguide therefore has an entrance for microwaves and an exit for microwaves. The entrance is provided at the magnetron. The exit is provided in a surface of the oven cavity, preferably through one or more apertures provided in the surface for this purpose. The aperture or apertures may be provided with a glass cover. The surface is preferably a wall surface.

In one embodiment, microwaves are arranged to enter the oven cavity, in use of the oven, from a wall located opposite the door of the oven: they are thereby rear-launched.

In a preferred embodiment, the oven comprises a housing which comprises a floor section, three wall sections and a ceiling section, said sections comprising or consisting of metal bodies, provided with or without apertures. One or more of these sections of the housing may be in the form of a panel or sheet. The or each metal body may be a metal panel or metal sheet, provided with or without apertures.

Preferably, the floor section comprises, and may consist of, the metal body provided with apertures. The metal body provided with apertures may therefore be a floor section of the oven housing.

The metal bodies of the housing, together with the oven door and the waveguide, are configured to contain microwave energy within the oven and to prevent leakage of microwave energy.

The apertures in the metal body or metal bodies may comprise perforations in the metal body or metal bodies. In one example, a perforated metal panel is provided as a metal body with apertures. The metal body or some or all of the metal bodies may have one or more regions provided with apertures and one or more regions provided without apertures. The metal body or metal bodies may be of stainless steel or mild steel.

The oven thereby comprises a Faraday cage, formed in this embodiment by the housing, the door and the waveguide. The Faraday cage retains the microwave energy within the oven. The oven cavity is located inside the Faraday cage. The ceramic base is located inside the Faraday cage.

The door may comprise a metal mesh or other means to contain microwave energy within the oven and to prevent leakage of microwave energy.

Preferably, the ceiling section of the housing separates the top section of the oven from the oven cavity and comprises a metal body provided with apertures. The apertures assist with allowing heated air to pass from the oven element into the oven cavity, without allowing microwave energy to leak from the oven cavity.

The first temperature sensor may be housed in a metal tube between the base element and the metal body provided with apertures. Alternatively, the first temperature sensor may be secured to the lower side of the metal body provided with apertures. In another embodiment, the first temperature sensor may be housed outside the Faraday cage of the oven but not between the base element and the metal body provided with apertures. In these ways, it is protected from microwaves and from possible contact with the base element. In these embodiments, no temperature sensor is provided in direct thermal contact with the ceramic base of the oven cavity as this would interfere adversely with the microwave radiation since any such temperature sensor would be inside the Faraday cage of the oven.

In another embodiment, the first temperature sensor may be housed inside the Faraday cage of the oven but in a suitably screened housing (for example a sealed metal tube) to protect it from microwaves.

The means for providing air circulation may comprise a fan provided in the top section of the oven in fluid communication with the oven cavity for moving air heated by the oven element within the oven cavity.

The fan may be in fluid communication with the oven cavity via one or more apertures, nozzles, vents and/or ducts (by way of example).

The oven element may be configured to surround the fan.

The oven element may be at least one substantially circular element or substantially annular element.

In one embodiment, the oven element consists of two substantially circular elements or substantially annular elements. The circular/annular elements may be concentric. The provision of two circular/annular elements provides adjustment of the heating power of the oven. In this respect, the heating power may be reduced by using a single circular/annular element and may be increased by using both circular/annular elements.

The oven element may be a sheathed element or elements and is preferably a tubular sheathed element or elements.

The means for heating may comprise an additional oven element as an alternative or additional means for adjusting (ie reducing/increasing) the heating power of the oven. The additional oven element may be provided in the top section of the oven.

The oven cavity is preferably cubic or cuboid in shape and is defined by three wall surfaces, the door, one ceiling surface and the ceramic base.

The wall surfaces may be the wall sections of the housing. The ceiling surface may be the ceiling section of the housing.

The controller is preferably configured in any heating cycle either to use the heating means independently or sequentially or to use two or more of the heating means simultaneously.

By providing multiple heating means and controlling their use (both simultaneous and asynchronous) it is possible to optimise and accelerate heating whilst also reducing peak power consumption. Different types of food may be cooked in a reduced time with the phased use of the different heating means optimised for the food being heated during any heating cycle. Different combinations/sequences of the heating means may be used for different foods to reduce cooking times.

In this respect, the microwaves enable food to be heated internally while the oven element and the base element enable food to be heated to turn it crisp and brown on its upper and lower surfaces and sides, while heating it externally.

The controller may comprise one or more control devices. The controller operates the various heating means and the various means for measuring temperature: it may also operate the means for providing air circulation. The controller may employ suitable hardware and/or software to perform its operations. The controller is preferably provided with a user interface.

In one embodiment, there are two temperature measuring inputs on the controller. These inputs allow the temperature within the oven cavity and the temperature of the ceramic base to be independently set and to be monitored via the first and second temperature sensors.

The first and second temperature sensors may be thermocouples, thermistors, mechanical thermostats or other similar devices.

The means for measuring temperature may further comprise one or more additional temperature sensors, such as a third temperature sensor configured to measure the temperature of the oven element.

The present invention relates to an oven and not to a warming drawer (for example).

Non-limiting embodiments will now be described, by way of example only, with reference to the accompanying diagrammatic drawings, in which:

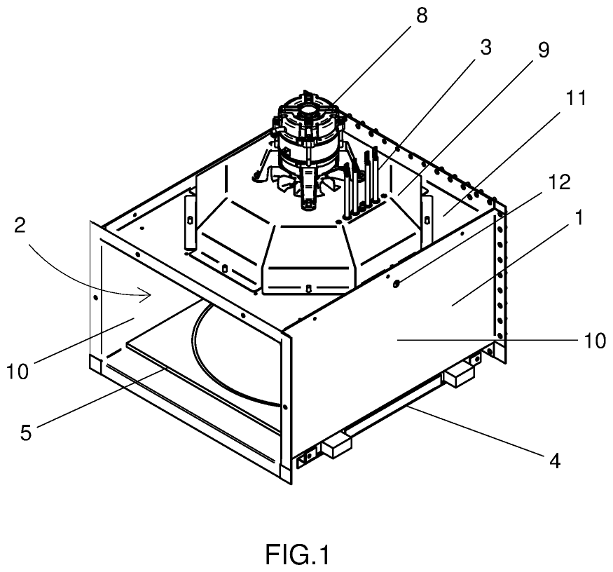

FIG. 1 shows a perspective view of internal components of an oven according to an embodiment of the present invention;

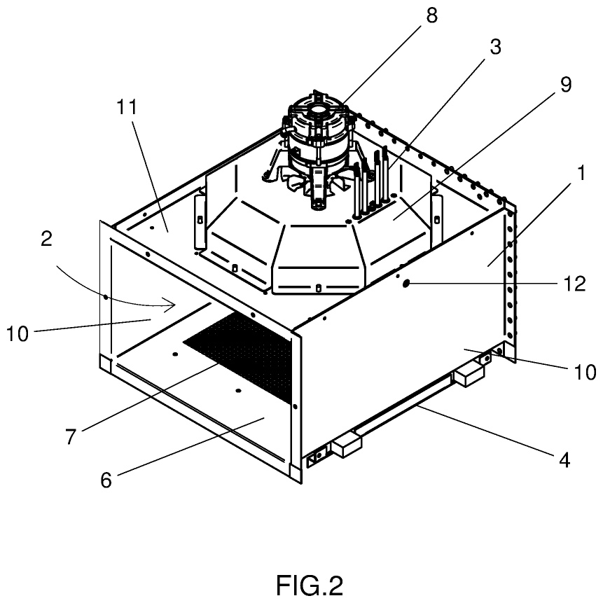

FIG. 2 shows a perspective view of internal components of an oven in accordance with FIG. 1 but with the ceramic base removed;

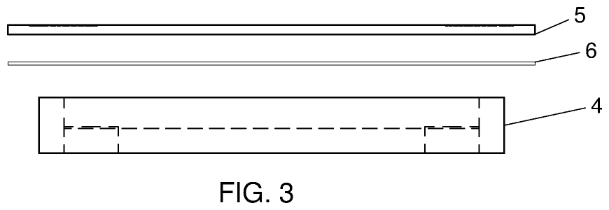

FIG. 3 is an exploded schematic side view of a base assembly of an oven;

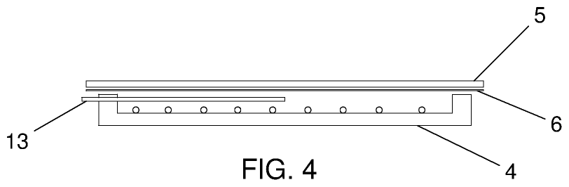

FIG. 4 is another exploded schematic side view of a base assembly of an oven including a temperature sensor;

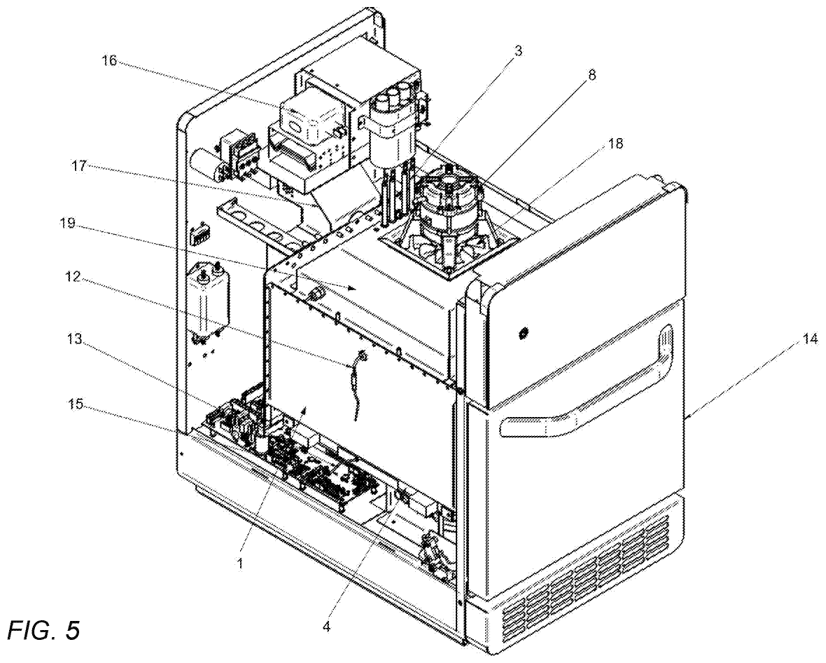

FIG. 5 is a perspective view of an oven according to another embodiment of the present invention;

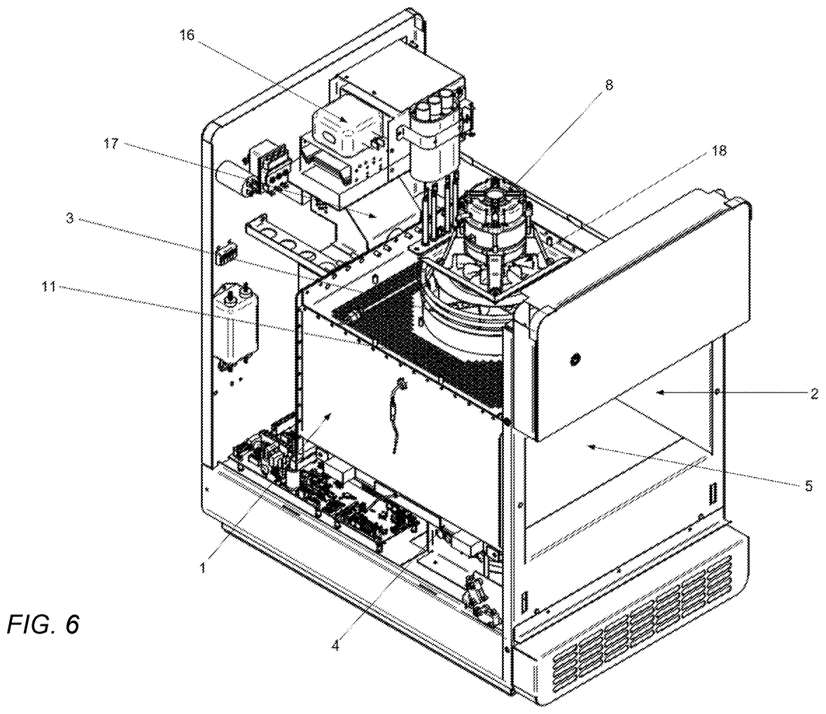

FIG. 6 is a perspective view of the oven of FIG. 5 with the door and a top air guide removed;

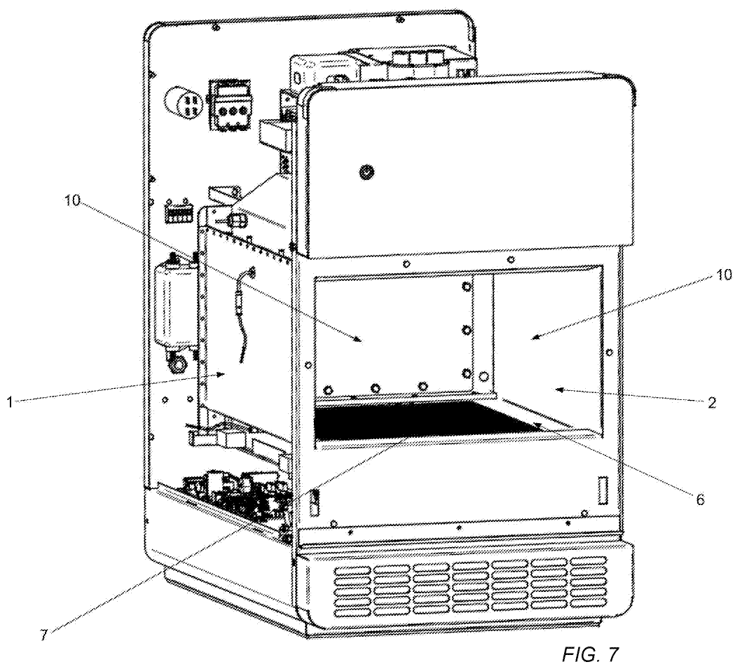

FIG. 7 is a perspective view of the oven of FIG. 5 with the door and the ceramic base removed; and

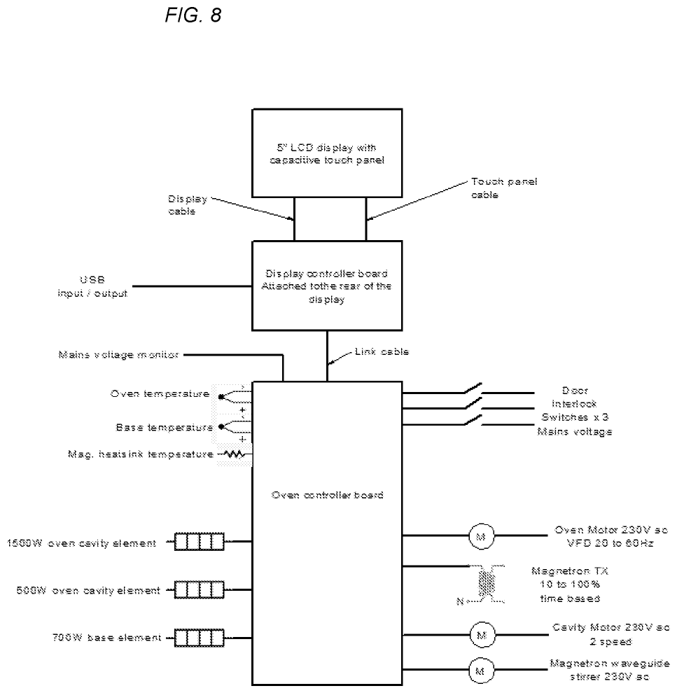

FIG. 8 depicts an arrangement of the controller.

With reference to the figures of both embodiments of the invention, there is shown an oven housing 1 and an oven cavity 2 for receiving a food product for heating.

The oven comprises the housing 1, a door 14 for closing the oven cavity 2, at least three means for heating and a controller 15 for controlling the operation of the heating means.

One heating means is an oven element 3 provided in a top section of the oven. Another heating means is a base element 4 provided in a base section of the oven. A further heating means is a microwave source, such as a magnetron 16, arranged to launch microwaves from a wall of the oven via a waveguide 17, this wall being located opposite the door 14 of the oven in this example, such the microwaves are rear-launched. The microwaves may instead be launched from a different surface of the oven cavity.

The base element 4 is provided under a ceramic base panel 5 that defines a base of the oven cavity. In the present arrangement the panel is formed from ceramic glass. It is not limited as such. For example, it could comprise alternative ceramic materials. The ceramic base of the oven cavity provides a heating surface which is heated by the base element 4. It is particularly suited to the heating of pizzas.

The housing 1 comprises a floor section 6 located between the ceramic base 5 of the oven cavity and the base element 4, and the floor section comprises a metal body provided with apertures 7 for the transfer of heated air. In the example shown, the apertures 7 are perforations located in a central region only of the floor section 6 which is in the form of a panel. The perforations are substantially aligned with the radiating area of the base element, in this example. A layer of high temperature sealant may be applied between the ceramic base 5 and the floor section 6 to prevent leakage from the oven cavity of substances such as fats, oils or cleaning liquids.

The base element 4 is a radiant element. The oven element 3 is a sheathed element which may be tubular. Such radiant elements and sheathed elements may take any conventional form or construction and the present invention is not to be limited to the specific form and construction of these elements. In the present arrangement, however, the base element is a fast-heat radiant element and the oven element is a metal sheathed element.

The oven element 3 may be circular or annular, as shown in FIG. 6, and may comprise one or more separate heating sections; for example, the oven element may be a sheathed element comprising two, three or four separate heating sections.

Air heated by the oven element within the oven cavity is moved to provide air circulation. In the arrangement shown, a fan 18 is provided for this purpose (further fans may also be provided). The oven element 3 surrounds the fan 18 in these embodiments. The fan is driven by a motor 8. The fan is in fluid communication with the oven cavity.

The fan 18 is preferably configured to draw air from the oven cavity via apertures provided in the ceiling section of the oven housing, to blow this air over the oven element and to blow air into the oven cavity via the apertures in the ceiling section. In this way, air trapped in the oven cavity 2 when the oven door is shut is heated and recirculated by the fan 18.

An octagonal cover 9 is provided in the embodiment of FIGS. 1 and 2 to direct the air heated by the oven element through one or more vents down the sides of the oven cavity 2, over the food and back into the centre of the oven in a substantially symmetrical manner. The octagonal cover is located around and above an annular oven element 3 in this embodiment. In other embodiments, the cover may be circular, rectangular or square in shape, for example. A square cover 19 is provided in the embodiment of FIGS. 5 to 7.

The oven comprises a catalytic converter in these embodiments. The catalytic converter is preferably provided in the top section of the oven. The catalytic converter is preferably provided externally of the Faraday cage, although it may form part of the Faraday cage as it is perforated.

The housing 1 comprises the floor section 6, three wall sections 10 and a ceiling section 11, said sections comprising metal bodies, provided with apertures if required.

The ceiling section 11 comprises a metal body provided with apertures for the transfer of heated air into the oven cavity 2 from the oven element 3.

At least two types of the heating means will preferably be used in any heating cycle (simultaneously or asynchronously or a combination of both). The use of at least two different types of heating means allows for optimised/accelerated cooking. The base element and/or a microwave source may be used simultaneously with the oven element. The controller may be configured in any heating cycle to use one or more of the base element or the microwave source.

In dependence on the food to be heated, different heating means may be used (in different combinations and/or sequences) during heating cycles to give the best result for different food types. A pre-heating step may be included or omitted in any heating cycle.

The controller may be user programmable such that the user can select which of the heating means are turned on, in which sequence/combination and for how long. The controller may additionally or alternatively be provided with a number of predefined user selectable programmes/programme stages, such as pizza, sandwich, etc. to allow user-friendly optimised and focused heating of a wide range of different products.

The controller is configured to control independently the temperature of the ceramic base and the temperature within the oven cavity, providing more accurate control of the cooking of food.

Referring to FIGS. 1, 2, 5, 6 and 7, a temperature sensor 12 is located in the oven cavity remote from the ceramic base. The external end of the temperature sensor 12 is shown: the internal end of the temperature sensor is located within the oven cavity and is not visible in these perspective views. Temperature sensor 12 is adjacent the top section of the oven in this embodiment. Temperature sensor 12 measures the air temperature in the oven cavity during the heating process. It may be a thermocouple. The thermocouple may be provided in a stainless steel sheath.

Referring to FIGS. 4, 5 and 6, a temperature sensor 13 is located in the base section of the oven and is located between the base element 4 and the floor 6. Temperature sensor 13 measures the air temperature below the ceramic base 5 during the heating process. It may be a thermocouple. The thermocouple may be provided in a stainless steel sheath.

The invention is not limited to this arrangement of the two temperatures sensors. For example, the temperature sensor 13 may be located elsewhere outside the oven cavity and adjacent the ceramic base or it may be located inside the oven cavity and adjacent the ceramic base (with suitable protection against microwaves).

FIG. 8 shows the general arrangement of the controller used in one embodiment of the present invention where the oven has three heating elements and a magnetron-based microwave source. The three heating elements are a 1500 W oven element, a 500 W oven element and a 700 W base element.

When the controller unit is switched on, and a program is selected, the controller unit uses the three heating elements to heat the oven cavity. The 1500 W and 500 W oven elements heat the air in the oven cavity to a set temperature, controlled by an oven temperature thermocouple (a temperature sensor). The base element heats the ceramic base to a set temperature controlled by a base temperature thermocouple (another temperature sensor). These two temperatures are set independently in the controller. When the air in the oven cavity is up to temperature, the unit is set to beep and switches from a pre-heating mode to a ready mode. During this heating phase, an oven fan circulates the hot air in the oven cavity. The microwave is not used in this pre-heating phase.

When a program is selected, the heat sources are given a priority rating to keep the power drawn below 3000 W (for example).

This priority sequence in this embodiment is
Microwave—approximately 2000 W
500 W oven element
700 W base element
1500 W oven element.

The controller is programmed to select heat sources in this order in this example so that, if the oven cavity air temperature falls with the microwave turned on, then it can only use the 500 W oven element to increase the temperature. If the air in the oven cavity is at temperature and the temperature of the ceramic base is cooler, it turns on the base element to raise the temperature to the set temperature point. If the microwave is not on, then the controller can turn on any of the elements it needs to maintain the set temperatures. Further detail is set out in FIG. 8.

The oven may be provided with one or more baking shelves (for foods not to be heated directly on the base). Any of the shelves may be fixed or more preferably height adjustable in the conventional manner.

Numerous variations and modifications will be readily conceived by those skilled in the art, within the scope of the present disclosure. Various combinations of heating means will be readily conceived by those skilled in the art, including the introduction of any known heating means suitable for use in an oven but not specifically referenced herein. In this respect, a grill element may be provided in the oven but in a preferred embodiment the oven of the present invention does not comprise a grill element. Various alternative controller configurations providing different combinations and/or sequences of any of the heating means provided in the oven may be implemented.

1. An oven defining an oven cavity for receiving a food product for heating, the oven comprising a door for closing the oven cavity, means for heating, means for providing air circulation, means for measuring temperature and a controller for controlling the operation of the means for heating and the operation of the means for measuring temperature, wherein
the means for heating comprises an oven element provided in a top section of the oven, a base element provided in a base section of the oven and a microwave source,
the oven cavity has a base which is ceramic and defines a heating surface which is arranged to be heated by the base element in use of the oven,
the base element is at least one radiant element,
a metal body provided with apertures is located in the base section of the oven and is located between the ceramic base of the oven cavity and the base element,
the metal body lies over at least part of the base element,
the means for measuring temperature comprises a first temperature sensor and a second temperature sensor,
the first temperature sensor is located in the base section of the oven and is located between the base element and the metal body,
the second temperature sensor is located in the oven cavity remote from the ceramic base, and
the controller is configured to control independently the temperature of the ceramic base and the temperature within the oven cavity.

2. An oven defining an oven cavity for receiving a food product for heating, the oven comprising a door for closing the oven cavity, means for heating, means for providing air circulation, means for measuring temperature and a controller for controlling the operation of the means for heating and the operation of the means for measuring temperature, wherein
the means for heating comprises an oven element provided in a top section of the oven, a base element provided in a base section of the oven and a microwave source,
the oven cavity has a base which is ceramic and defines a heating surface which is arranged to be heated by the base element in use of the oven,
the base element is at least one radiant element,
a metal body provided with apertures is located in the base section of the oven and is located between the ceramic base of the oven cavity and the base element,
the metal body lies over at least part of the base element,
the means for measuring temperature comprises a first temperature sensor and a second temperature sensor,
the first temperature sensor is located inside or outside the oven cavity adjacent the ceramic base,
the second temperature sensor is located in the oven cavity remote from the ceramic base, and
the controller is configured to control independently the temperature of the ceramic base and the temperature within the oven cavity.

3. The oven of claim 1 or claim 2, wherein the metal body lies substantially over the region or regions of the base element that are configured to radiate heat in use of the oven.

4. The oven of claim 3, wherein the apertures in the metal body are provided in one or more regions which are substantially aligned with the region or regions of the base element that are configured to radiate heat in use of the oven.

5. The oven of claim 1 or claim 2, wherein the ceramic base of the oven cavity is ceramic glass.

6. The oven of claim 1 or claim 2, wherein microwaves are arranged to enter the oven cavity, in use of the oven, from a wall located opposite the door of the oven.

7. The oven of claim 1 or claim 2, comprising a housing which comprises three wall sections, a floor section and a ceiling section, wherein the floor section comprises the metal body provided with apertures.

8. The oven of claim 7, wherein the ceiling section separates the top section of the oven from the oven cavity and comprises a metal body provided with apertures.

9. The oven of claim 1 or claim 2, wherein the means for providing air circulation comprises a fan provided in the top section of the oven and in fluid communication with the oven cavity for moving air heated by the oven element within the oven cavity.

10. The oven of claim 9, wherein the oven element is configured to surround the fan.

11. The oven of claim 1 or claim 2, wherein the oven element is at least one substantially circular element or substantially annular element.

12. The oven of claim 1 or claim 2, wherein the oven element is at least one sheathed element.

13. The oven of claim 12, wherein the oven element is at least one tubular sheathed element.

14. The oven of claim 1 or claim 2, wherein the controller is configured in any heating cycle either to use the heating means independently or sequentially or to use two or more of the heating means simultaneously.

15. The oven of claim 1 or claim 2, wherein the housing, the door and a waveguide provide a Faraday cage and the ceramic base of the oven cavity is located inside the Faraday cage.
